(19) United States
(12) Patent Application Publication
(10) Pub. No.: US 2020/0004739 A1
(43) Pub. Date: Jan. 2, 2020

(54) INFORMATION MANAGEMENT DEVICE, INFORMATION MANAGEMENT METHOD, AND RECORDING MEDIUM ON WHICH INFORMATION MANAGEMENT PROGRAM IS STORED

(71) Applicant: NEC Corporation, Minato-ku, Tokyo (JP)

(72) Inventor: Kenichiro ISHIKAWA, Tokyo (JP)

(73) Assignee: NEC Corporation, Minato-ku, Tokyo (JP)

(21) Appl. No.: 16/490,635

(22) PCT Filed: Mar. 6, 2018
(86) PCT No.: PCT/JP2018/008520

§ 371 Date: Sep. 3, 2019

(30) Foreign Application Priority Data
Mar. 9, 2017 (JP) 2017-044847

(51) Int. Cl. G06F 16/23; G06F 16/22

(52) U.S. Cl. CPC G06F 16/2379; G06F 16/2246

(57) ABSTRACT

An information management device includes: an identification unit that identifies, when any piece of information among plural pieces of information managed by constructing a structural model representing a mutual relevance is deleted from the structural model, information-to-be-modified having the relevance with information deleted (deleted information) meeting a predetermined condition in the structural model before deletion of the deleted information, among the plural pieces of managed information; and a modification unit that modifies, based on a criterion relating to the relevance and a configuration of the structural model before deletion of the deleted information, a configuration of the structural model relating to the identified information-to-be-modified, thereby efficiently performing processing of reconstructing a structural model representing a mutual relevance when any piece among plural pieces of information managed by constructing the structural model is deleted.

### TECHNICAL FIELD

The invention of the present application relates to a technique of managing a plurality of pieces of information by constructing a structural model representing a mutual relevance.

### BACKGROUND ART

When a large number of pieces of information are managed, various types of processing on those pieces of information to be managed (information-to-be-managed) are enabled by constructing a structural model (by structuring pieces of information) that represents a mutual relevance relating to those pieces of information. As an example of such a structural model, a model is contemplated in which pieces of information are linked (associated) with each other by using an edge representing a relevance between those pieces of information. As one example in this case, in a structural model having a tree structure, for example, second information having a relevance with first information is arranged on an edge of the first information.

Further, a system that performs various types of processing on information-to-be-managed stores the information-to-be-managed by, for example, defining a function (evaluation function) for evaluating a distance (a degree of relevance) between two pieces of information, and constructing a structural model having a tree structure. FIG. 16 illustrates one example of a general information group constructing such a structural model having a tree structure. As exemplified in FIG. 16, such a structural model normally includes a node including a plurality of pieces of information, and an edge connecting information to a node. Then, on a root node (root) of the tree structure, representative pieces of information being far from (having a low relevance with) one another are arranged. On a child node, information being close in distance to (having a high relevance with) information connected to the child node in a parent node is arranged. Then, information-to-be-managed is arranged in such a way that a distance between pieces of information included in an identical node is closer in a node being closer to a terminal of the tree structure (being lower in hierarchy: a child node and a grandchild node).

A system that manages information by using such a structural model calculates, when retrieving information having a highest relevance with information that is input (input information), a distance between the input information and information arranged in the structural model, by using an evaluation function. Then, the system can retrieve target information at high speed by tracing, on the basis of a tree structure, information being close in distance.

As a technique relevant to the technique of managing information by constructing a structural model in this manner, PTL 1 discloses a computer that generates, on the basis of correlation matrix data having a correlation value between a plurality of indices as an element, graph data including a vertex associated with a single index, an edge connecting two correlated vertices, and an edge weight being a value of an element. This computer acquires correlation matrix data from a storage device, and extracts an element constructing a spanning tree that links vertices associated with an index included in the acquired correlation matrix data and an element having a value equal to or greater than a predetermined threshold value. The computer generates graph data on the basis of the extracted elements.

Further, PTL 2 discloses an index generation device that generates, by using a similarity between pieces of data calculated by a similarity calculation unit, an index including a lower order node and a higher order node. However, the higher order node is a node including an entry that has a link relevance with the lower order node and indicates representative data having a similarity with data indicated by an entry of the lower order node being equal to or greater than a similarity threshold value given to the link relevance. Then, this index generation device determines the similarity threshold value to be a value that is greater as being lower in hierarchy.

### CITATION LIST

### Patent Literature

[PTL 1] International Publication WO 2016/157275

[PTL 2] International Publication WO 2014/109127

### Summary of Invention

### Technical Problem

When a plurality of pieces of information-to-be-managed are managed by constructing a structural model representing a mutual relevance as described above, there arises a problem when any piece of information is deleted. In other words, in this case, since information indicated by an edge having been connected to the deleted information-to-be-managed (deleted information) is lost, there arises a problem that information on a relevance between pieces of information-to-be-managed decreases, disappears, or the like.

For example, in a structural model having a tree structure as exemplified in FIG. 16, when any piece of information is deleted, a node having been connected to an edge having extended from the deleted information is caused to be isolated from the tree structure. In this case, it is necessary to reevaluate, for information included in the isolated node, a degree of relevance with another piece of information, and to reconstruct a (restructured) structural model in which the isolated information is again connected to the structural model on the basis of a result of the reevaluation. However, a huge amount of information-to-be-managed requires a huge amount of computation for reconstructing a structural model, which causes a trouble in operation of information management. PTLs 1 and 2 do not mention this problem particularly. A main object of the invention of the present application is to provide an information management device and the like that solve such a problem.

### Solution to Problem

An information management device according to one aspect of the invention of the present application includes: an identification means for identifying, when any piece of information among a plurality of pieces of managed information managed by constructing a structural model representing a mutual relevance is deleted from the structural model, information-to-be-modified having the relevance with the information being deleted (“deleted information” hereinafter) meeting a predetermined condition in the structural model before deletion of the deleted information, among the plurality of pieces of the managed information; and a modification means for modifying, on the basis of a criterion relating to the relevance and a configuration of the structural model before deletion of the deleted information, a configuration of the structural model relating to the information-to-be-modified being identified.

In another perspective for achieving the above-described object, an information management method according to one aspect of the invention of the present application includes: by using an information processing device, identifying, when any piece of information among a plurality of pieces of managed information managed by constructing a structural model representing a mutual relevance is deleted from the structural model, information-to-be-modified having the relevance with the information being deleted (“deleted information” hereinafter) meeting a predetermined condition in the structural model before deletion of the deleted information, among the plurality of pieces of the managed information; and modifying, on the basis of a criterion relating to the relevance and a configuration of the structural model before deletion of the deleted information, a configuration of the structural model relating to the information-to-be-modified being identified.

Further, in still another perspective for achieving the above-described object, an information management program according to one aspect of the invention of the present application is a program that causes a computer to execute: identification processing of identifying, when any piece of information among a plurality of pieces of managed information managed by constructing a structural model representing a mutual relevance is deleted from the structural model, information-to-be-modified having the relevance with the information being deleted (“deleted information” hereinafter) meeting a predetermined condition in the structural model before deletion of the deleted information, among the plurality of pieces of the managed information; and modification processing of modifying, on the basis of a criterion relating to the relevance and a configuration of the structural model before deletion of the deleted information, a configuration of the structural model relating to the identified information-to-be-modified.

Furthermore, the invention of the present application can be also achieved by a computer-readable non-volatile recording medium on which the information management program (computer program) is stored.

### Advantageous Effects of Invention

The invention of the present application is able to efficiently perform processing of reconstructing a structural model representing a mutual relevance when any piece among a plurality of pieces of information managed by constructing the structural model is deleted.

### BRIEF DESCRIPTION OF DRAWINGS

FIG. 1 is a block diagram illustrating a configuration of an information management device 10 according to a first example embodiment of the invention of the present application.

FIG. 2 is a diagram exemplifying a configuration of a structural model forming an information group 100 according to the first example embodiment of the invention of the present application.

FIG. 3 is a diagram illustrating one example of screen display to be displayed on a display screen 15 when an input unit 14 accepts an instruction to delete any piece of information included in the information group 100 according to the first example embodiment of the invention of the present application.

FIG. 4 is a diagram exemplifying a first intermediate form of the structural model in a process in which the information management device 10 reconstructs the structural model forming the information group 100 after information 1100 is deleted from the information group 100 according to the first example embodiment of the invention of the present application.

FIG. 5 is a diagram exemplifying a second intermediate form of the structural model in a process in which the information management device 10 reconstructs the structural model forming the information group 100 after information 1100 is deleted from the information group 100 according to the first example embodiment of the invention of the present application.

FIG. 6 is a diagram exemplifying a result (a final form) of the structural model forming the information group 100 reconstructed by the information management device 10 after information 1100 is deleted from the information group 100 according to the first example embodiment of the invention of the present application.

FIG. 7A is a flowchart (1/2) illustrating an operation of the information management device 10 according to the first example embodiment of the invention of the present application.

FIG. 7B is a flowchart (2/2) illustrating an operation of the information management device 10 according to the first example embodiment of the invention of the present application.

FIG. 8 is a block diagram illustrating a configuration of an information management device 10A according to a second example embodiment of the invention of the present application.

FIG. 9 is a diagram exemplifying a first intermediate form of a structural model in a process in which the information management device 10A reconstructs the structural model forming an information group 100 after information 1100 is deleted from the information group 100 according to the second example embodiment of the invention of the present application.

FIG. 10 is a diagram exemplifying a second intermediate form of the structural model in a process in which the information management device 10A reconstructs the structural model forming the information group 100 after information 1100 is deleted from the information group 100 according to the second example embodiment of the invention of the present application.

FIG. 11 is a diagram exemplifying a third intermediate form of the structural model in a process in which the information management device 10A reconstructs the structural model forming the information group 100 after information 1100 is deleted from the information group 100 according to the second example embodiment of the invention of the present application.

FIG. 12 is a diagram exemplifying a result (a final form) of the structural model forming the information group 100 reconstructed by the information management device 10A after information 1100 is deleted from the information group 100 according to the second example embodiment of the invention of the present application.

FIG. 13A is a flowchart (1/2) illustrating an operation of the information management device 10A according to the second example embodiment of the invention of the present application.

FIG. 13B is a flowchart (2/2) illustrating an operation of the information management device 10A according to the second example embodiment of the invention of the present application.

FIG. 14 is a block diagram illustrating a configuration of an information management device 20 according to a third example embodiment of the invention of the present application.

FIG. 15 is a block diagram illustrating a configuration of an information processing device 900 capable of executing the information management device according to each example embodiment of the invention of the present application.

FIG. 16 is a diagram exemplifying a configuration of a general information group constructing a structural model having a tree structure.

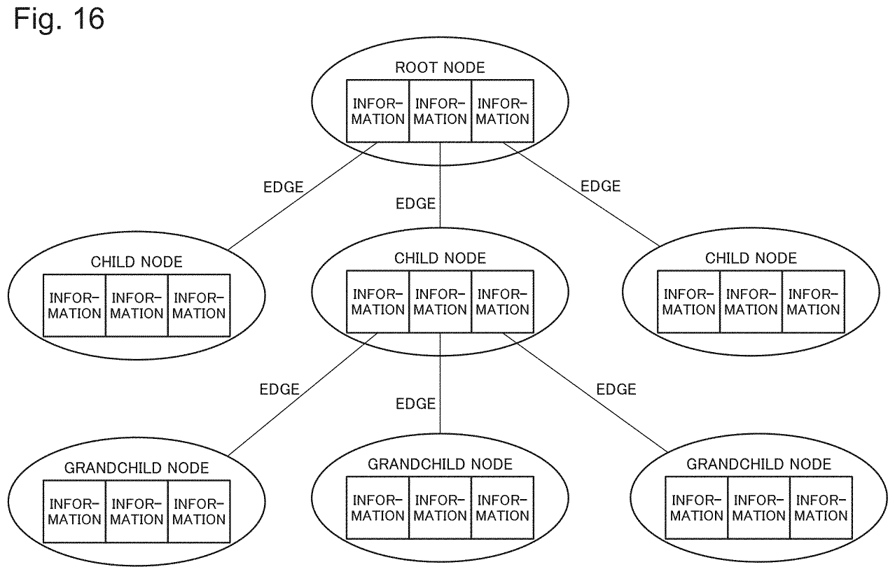

### EXAMPLE EMBODIMENT

Example embodiments of the invention of the present application will be described below in detail with reference to the drawings.

### First Example Embodiment

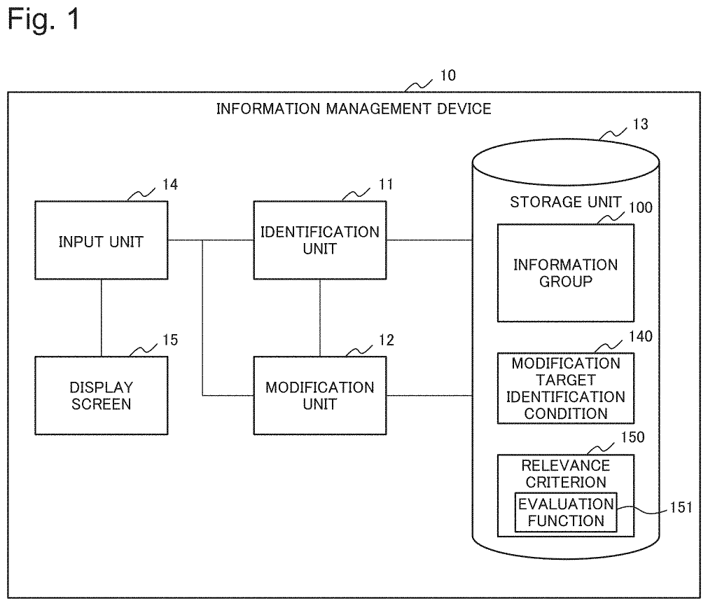

FIG. 1 is a block diagram conceptually illustrating a configuration of an information management device 10 according to a first example embodiment of the invention of the present application. The information management device 10 is a device that manages a plurality of pieces of information included in, for example, a database or the like, by constructing a structural model representing a mutual relevance. Information to be managed by the information management device 10 is information that represents, for example, a text, an image such as a face image, a molecular structure of a substance such as a deoxyribonucleic acid sequence, or the like.

The information management device 10 includes an identification unit 11, a modification unit 12, a storage unit 13, an input unit 14, and a display screen 15. The storage unit 13 is a storage device such as, for example, a magnetic disk or an electronic memory. The storage unit 13 stores an information group 100 being a plurality of pieces of information to be managed by the information management device 10. The storage unit 13 further stores a modification target identification condition 140 and a relevance criterion 150. The modification target identification condition 140 will be described later. The relevance criterion 150 is a criterion that should be met by a relevance between pieces of information represented by a structural model forming the information group 100 (hereinafter in the present application, simply referred to as a structural model sometimes). The relevance criterion 150 includes an evaluation function 151. The evaluation function 151 is a function that outputs a value indicating a relevance between any two pieces of information included in the information group 100. The evaluation function 151 evaluates, as one example of a value indicating a relevance, for example, a similarity relating to two pieces of information, and outputs a result of the evaluation. In other words, the evaluation function 151 outputs a similarity relating to two pieces of information, regarding, for example, the text, the face image, the deoxyribonucleic acid sequence, or the like described above.

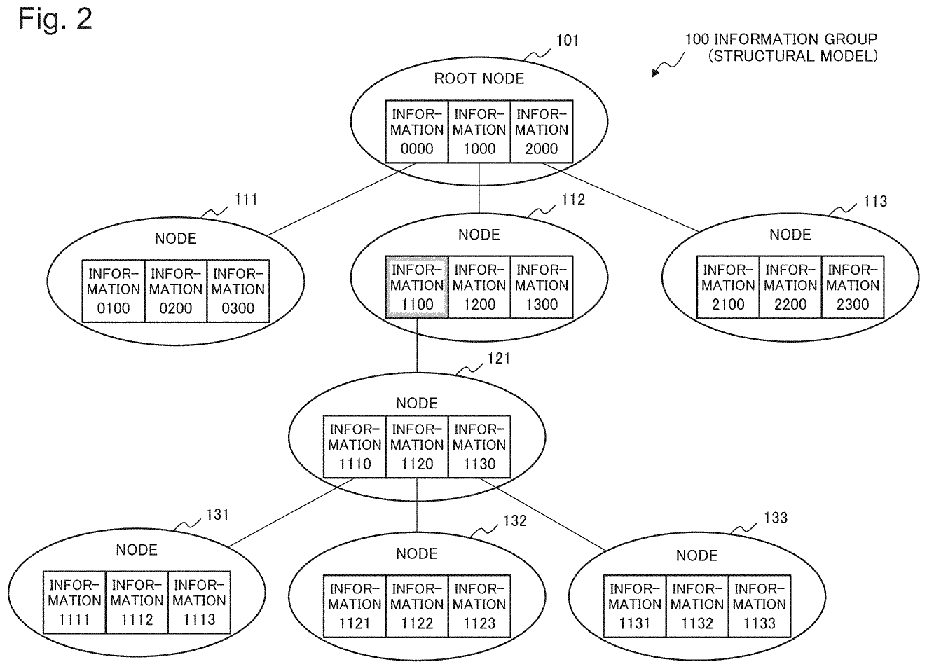

FIG. 2 is a diagram exemplifying a configuration of the structural model forming the information group 100 according to the present example embodiment. As exemplified in FIG. 2, the structural model forming the information group 100 according to the present example embodiment has a tree structure. The information group 100 includes a root node 101, nodes 111 to 113 connected to the root node 101 as child nodes, a node 121 connected to the node 112 as a child node, and nodes 131 to 133 connected to the node 121 as child nodes. The root node 101 includes three pieces of information: information 0000, information 1000, and information 2000. The other nodes in the information group 100 respectively include three pieces of information, similarly to the root node 101.

It is assumed that, regarding arrangement of information, for example, the following policies are applied to the structural model forming the information group 100 according to the present example embodiment. In other words, the relevance criterion 150 stored in the storage unit 13 includes the following policies.
1. The root node 101 includes information having a low degree (a result of evaluation performed by the evaluation function 151) indicating a mutual relevance.
2. Information (parent information) included in a node may have a child node connected thereto.
3. A result of evaluation performed by the evaluation function 151 relating to between information included in a child node and parent information to which the child node is connected is equal to or greater than a predetermined value.
4. A result of evaluation performed by the evaluation function 151 relating to between information included in a child node and parent information to which the child node is connected is higher as closer to a terminal of the structural model.

For the information group 100 to which such policies are applied, a retrieval system (not illustrated) that retrieves, for example, information most similar to information having been input (input information) operates as follows, for example. In other words, the retrieval system calculates a similarity between input information and each of information 0000, information 1000, and information 2000 included in the root node 101, by using the evaluation function 151, and thereafter identifies information most similar to the input information among information 0000, information 1000, and information 2000. The retrieval system then calculates a similarity between the input information and each piece of information included in a node connected to the identified information as a child node, by using the evaluation function 151, and thereafter identifies information most similar to the input information among the pieces of information included in the node. The retrieval system repeatedly performs the above-described processing toward a terminal direction of the structural model until no child node is connected to the information identified as being the most similar information. By performing such processing, the retrieval system is able to efficiently identify information most similar to input information among pieces of information included in the information group 100.

As one characteristic exhibited by the structural model forming the information group 100, an evaluation result relating to between pieces of information connected to different pieces of information included in a certain node may be relatively low in comparison with an evaluation result relating to between pieces of information included in a child node connected to a certain piece of information included in the node. More specifically, for example, in the information group 100 illustrated in FIG. 2, for example, an evaluation result relating to between information 1111 included in the node 131 and information 1121 included in the node 132 is relatively low in comparison with an evaluation result relating to between information 1111 and information 1112 included in the node 131. The structural model forming the information group 100 is configured in such a way that this tendency relating to an evaluation result between pieces of information is stronger in information being closer to the root node 101.

The input unit 14 illustrated in FIG. 1 accepts information input by a user by using an input device such as, for example, a keyboard, or a mouse. The display screen 15 is a screen to be referred by a user for performing an input operation. The input unit 14 displays, on the display screen 15, a menu screen for a user to perform operation input.

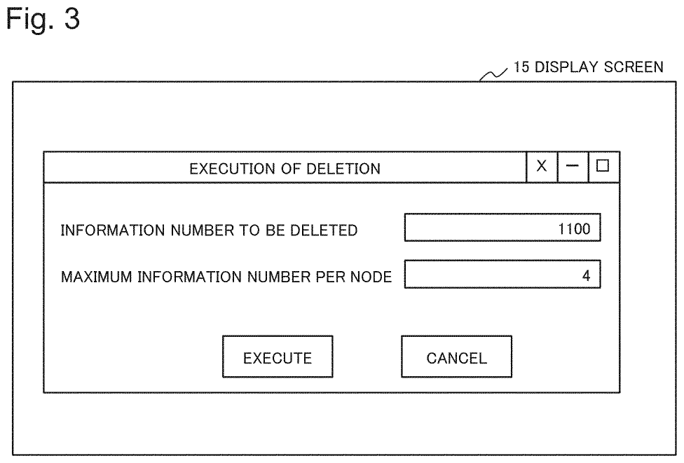

FIG. 3 is a diagram exemplifying screen display to be displayed on the display screen 15 when the input unit 14 accepts an instruction to delete any piece of information included in the information group 100 according to the first example embodiment of the invention of the present application. The input unit 14 accepts an information number to be deleted (an identifier capable of identifying information to be deleted) input by a user. In an example illustrated in FIG. 3, information 1100 included in the information group 100 exemplified in FIG. 2 is designated as a target to be deleted.

The input unit 14 further accepts a maximum information number per node input by a user. The maximum information number per node is a value to be designated as a condition relating to a characteristic that should be met by the structural model forming the information group 100 after designated information is deleted. In the example illustrated in FIG. 3, for example, “4” is designated as the value. In other words, in this case, the information management device 10 reconstructs the structural model after information 1100 is deleted from the information group 100, in such a way that the number of pieces of information included in each node in the structural model forming the information group 100 is equal to or less than “4”. The information management device 10 reflects the input condition relating to the characteristic that should be met by the structural model forming the information group 100, on the relevance criterion 150 stored in the storage unit 13.

The condition relating to the characteristic that should be met by the structural model forming the information group 100 does not need to be limited to the above-described maximum information number per node, and may be another condition. Further, the condition relating to the characteristic that should be met by the structural model does not need to be designated via the input unit 14. The information management device 10 may use, for example, a characteristic of the structural model before processing of deleting information, as the condition relating to the characteristic that should be met by the structural model after processing of deleting information.

When any piece of information included in the information group 100 is deleted from the structural model, the identification unit 11 illustrated in FIG. 1 identifies information-to-be-modified included in the information group 100 on the basis of the modification target identification condition 140 stored in the storage unit 13. The information-to-be-modified is information to be a target for modifying a relevance with another piece of information when the structural model is reconstructed upon deletion of any piece of information included in the information group 100 from the structural model. Thus, the modification target identification condition 140 indicates, for example, a condition for identifying information influenced at a predetermined level or more, regarding a relevance with another piece of information, when any piece of information is deleted from the structural model.

The modification unit 12 illustrated in FIG. 1 modifies, on the basis of the relevance criterion 150 and a configuration of the structural model before deletion of deleted information, the configuration of the structural model relating to information-to-be-modified identified by the identification unit 11.

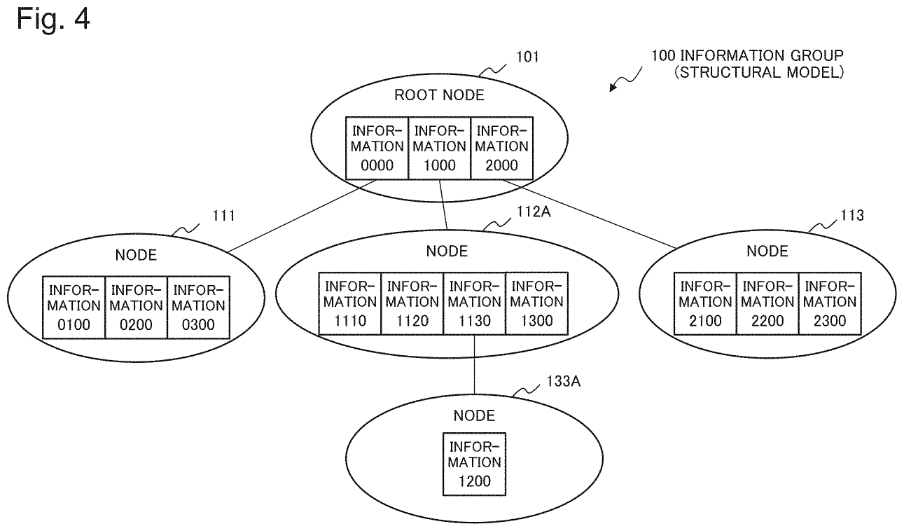

Next, processing of reconstructing the structural model performed by the identification unit 11 and the modification unit 12 according to the present example embodiment when information 1100 is deleted from the structural model forming the information group 100 exemplified in FIG. 2 will be described in detail with reference to FIGS. 4 to 6.

The identification unit 11 identifies, as information-to-be-modified, information 1200 and information 1300 included in the node 112 in which deleted information 1100 has been included as exemplified in FIG. 2, on the basis of the modification target identification condition 140. The identification unit 11 further identifies, as information-to-be-modified, information 1110, information 1120, and information 1130 having been included in the node 121 being a child node of deleted information 1100 as exemplified in FIG. 2, on the basis of the modification target identification condition 140. In other words, in this case, the modification target identification condition 140 indicates, as a condition for identifying information-to-be-modified, information included in a node in which the deleted information has been included before the deleted information is deleted, and in a node having been connected in a terminal direction of the structural model with the node as an origin (that is, a child node, a grandchild node, and the like having been connected to the deleted information).

FIG. 4 is a diagram exemplifying a first intermediate form of the structural model in a process in which the identification unit 11 and the modification unit 12 reconstruct the structural model forming the information group 100 after information 1100 is deleted from the information group 100 according to the present example embodiment. For information 1200, information 1300, information 1110, information 1120, and information 1130, which are identified by the identification unit 11 as information-to-be-modified, the modification unit 12 modifies the structural model, for example, as exemplified in FIG. 4, on the basis of the relevance criterion 150 and a configuration of the structural model before deletion of information 1100.

The modification unit 12 may incorporate the above-described five pieces of information-to-be-modified into the structural model, for example, in random order. As exemplified in FIG. 4, the modification unit 12 generates a node 112A as a child node of information 1000 having been parent information of deleted information 1100, and allows the node 112A to include information 1110, information 1120, information 1130, and information 1300. The number of pieces of information included in the node 112A meets “4” being the maximum information number per node input by a user, as exemplified in FIG. 3. Including information 1110, information 1120, information 1130, and information 1300 in the same node is due to a low evaluation value given by the evaluation function 151 relating to between these four pieces of information. Then, the modification unit 12 generates a node 133A as a child node of information 1130, and allows the node 133A to include information 1200. Including information 1200 in the node 133A being a child node of information 1130 is due to a high evaluation value given by the evaluation function 151 relating to between information 1130 and information 1200.

Among the above-described five pieces of information-to-be-modified, the identification unit 11 identifies, as next information-to-be-modified, four pieces of information (that is, information 1110, information 1120, information 1300, and information 1200) having no child node in the structural model in a state exemplified in FIG. 4. For information having had a child node connected thereto in the structural model before deletion of information 1100 among the identified four pieces of information-to-be-modified, the modification unit 12 connects the child node having been connected to the information, directly (in the case of the child node including a plurality of pieces of information, the plurality of pieces of information collectively) to the information-to-be-modified.

As exemplified in FIG. 2, among information 1110, information 1120, information 1300, and information 1200, information 1110 has the node 131 connected thereto as a child node and information 1120 has the node 132 connected thereto as a child node, in the structural model before deletion of information 1100. Thus, the modification unit 12 connects the node 131 to information 1110 as a child node and connects the node 132 to information 1120 as a child node, in the structural model in a state exemplified in FIG. 4.

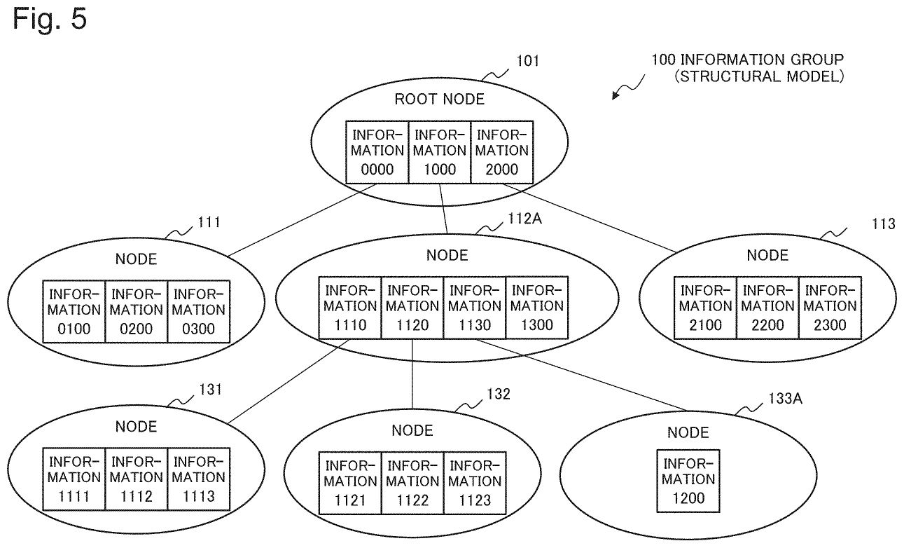

FIG. 5 is a diagram exemplifying a second intermediate form of the structural model representing a result of the above-described processing performed by the identification unit 11 and the modification unit 12 on the structural model in a state exemplified in FIG. 4.

The identification unit 11 identifies, as further next information-to-be-modified, information (that is, information 1130) having a child node, among the initially identified five pieces of information-to-be-modified. As exemplified in FIG. 2, information 1130 has the node 133 connected thereto as a child node in the structural model before deletion of information 1100. In this case, the modification unit 12 modifies the structural model in such a way that the node 133 exemplified in FIG. 2 and the node 133A exemplified in FIG. 4 are subordinate to information 1130 (are connected in a terminal direction of the structural model with information 1130 as an origin).

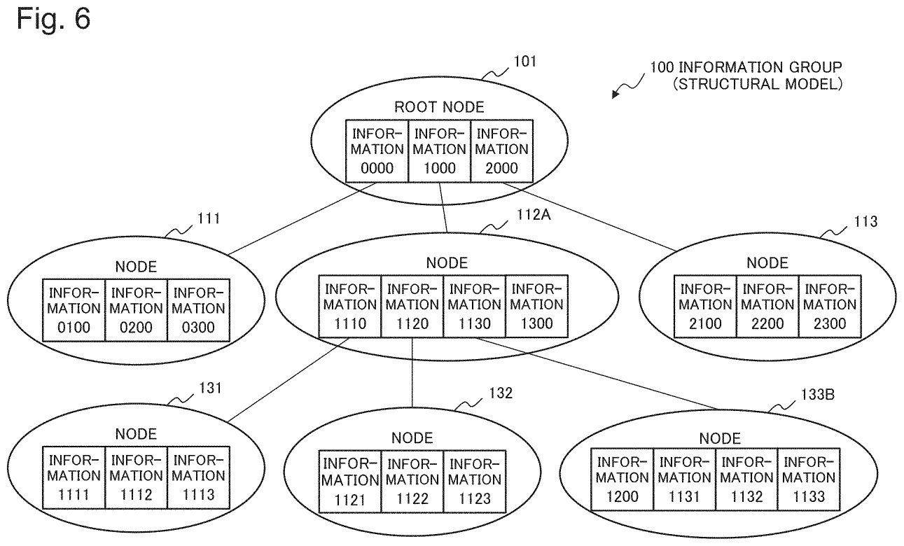

FIG. 6 is a diagram exemplifying a result of the above-described processing performed by the identification unit 11 and the modification unit 12 on the structural model in a state exemplified in FIG. 5. The modification unit 12 generates a node 133B integrating the node 133 exemplified in FIG. 2 with the node 133A exemplified in FIG. 4, and allows the node 133B to include information 1200, information 1131, information 1132, and information 1133. The number of pieces of information included in the node 133B meets “4” being the maximum information number per node input by a user, as exemplified in FIG. 3. Including information 1200, information 1131, information 1132, and information 1133 in the same node is due to a low evaluation value given by the evaluation function 151 relating to between these four pieces of information.

The structural model in a state exemplified in FIG. 6 includes all pieces of information other than information 1100 included in the structural model before deletion of information 1100 exemplified in FIG. 2. Thus, FIG. 6 represents a result (that is, a final form) of the structural model forming the information group 100 reconstructed by the information management device 10 after information 1100 is deleted from the information group 100 according to the present example embodiment.

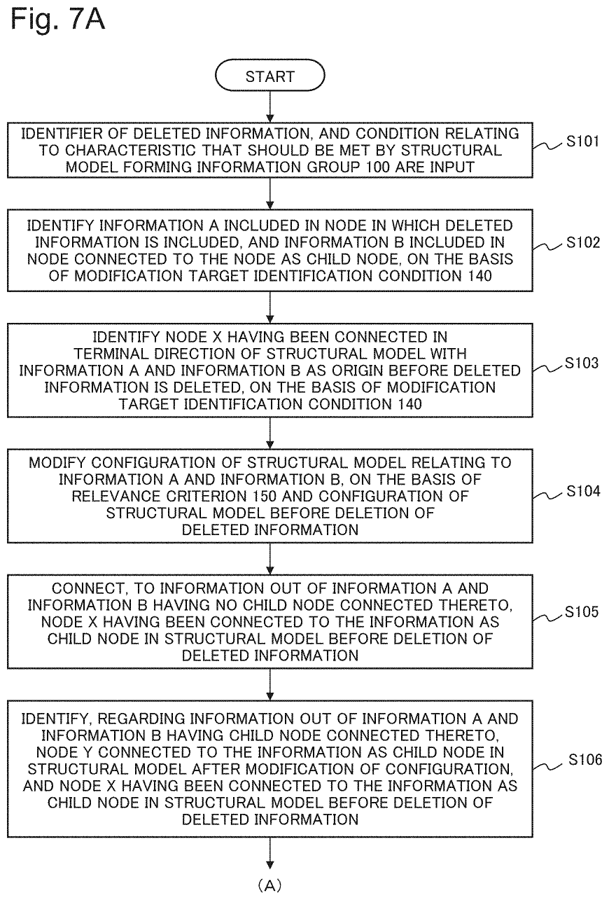

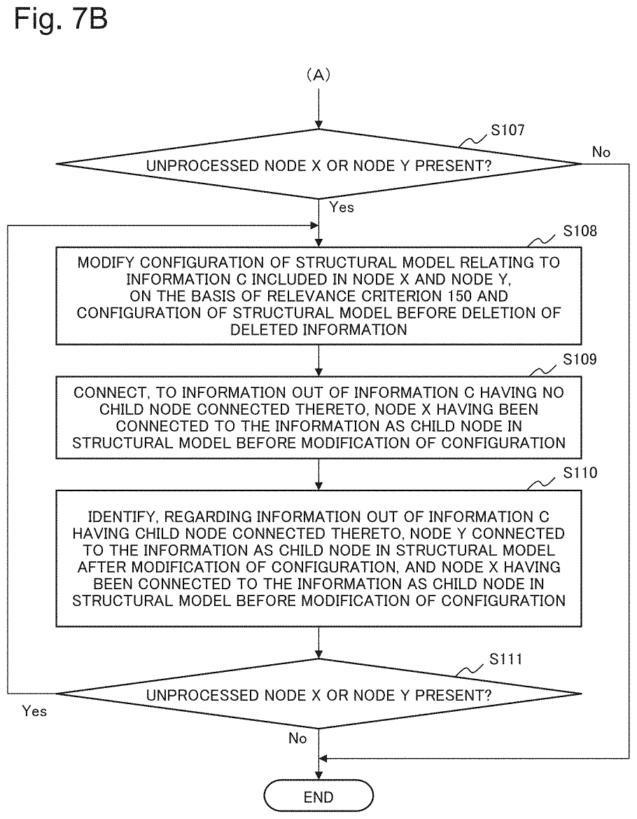

Next, an operation (processing) of the information management device 10 according to the present example embodiment will be described in detail with reference to flowcharts in FIGS. 7A and 7B.

The input unit 14 accepts input of an identifier of deleted information to be deleted from the information group 100, and a condition relating to a characteristic that should be met by the structural model forming the information group 100 (Step S101). The identification unit 11 identifies information A included in a node in which the deleted information is included and information B included in a node connected to the node as a child node, on the basis of the modification target identification condition 140 (Step S102). The identification unit 11 identifies node X having been connected in a terminal direction of the structural model with information A and information B as an origin before the deleted information is deleted, on the basis of the modification target identification condition 140 (Step S103).

The modification unit 12 modifies a configuration of the structural model relating to information A and information B, on the basis of the relevance criterion 150 and the configuration of the structural model before deletion of the deleted information (Step S104). The modification unit 12 connects, to information out of information A and information B having no child node connected thereto, node X having been connected to the information as a child node in the structural model before deletion of the deleted information (Step S105). The identification unit 11 identifies, regarding information out of information A and information B having a child node connected thereto, node Y connected to the information as a child node in the structural model after modification of the configuration, and node X having been connected to the information as a child node in the structural model before deletion of the deleted information (Step S106).

When no unprocessed node X and node Y are present (No in Step S107), the entire processing ends. When unprocessed node X or node Y is present (Yes in Step S107), the modification unit 12 modifies the configuration of the structural model relating to information C included in node X and node Y, on the basis of the relevance criterion 150 and the configuration of the structural model before deletion of the deleted information (Step S108). The modification unit 12 connects, to information out of information C having no child node connected thereto, node X having been connected to the information as a child node in the structural model before modification of the configuration (Step S109).

The identification unit 11 identifies, regarding information out of information C having a child node connected thereto, node Y connected to the information as a child node in the structural model after modification of the configuration, and node X having been connected to the information as a child node in the structural model before modification of the configuration (Step S110). When unprocessed node X or node Y is present (Yes in Step S111), the processing returns to Step S108. When no unprocessed node X and node Y are present (No in Step S111), the entire processing ends.

The information management device 10 according to the present example embodiment is able to efficiently perform processing of reconstructing a structural model representing a mutual relevance when any piece among a plurality of pieces of information managed by constructing the structural model is deleted. The reason is that the information management device 10 identifies, as information-to-be-modified, information having a relevance with deleted information meeting the modification target identification condition 140, and modifies, on the basis of the relevance criterion 150 and a configuration of the structural model before deletion of the deleted information, the configuration of the structural model relating to the information-to-be-modified.

An advantageous effect implemented by the information management device 10 according to the present example embodiment will be described below in detail.

When a plurality of pieces of information-to-be-managed are managed by constructing a structural model representing a mutual relevance, there arises a problem when any piece of information is deleted. In other words, in this case, since information indicated by an edge having been connected with the deleted information is lost, there arises a problem that information on a relevance between pieces of information-to-be-managed decreases, disappears, or the like.

For example, in a structural model having a tree structure, when any piece of information is deleted, a node having been connected to an edge having extended from the deleted information is caused to be isolated from the tree structure. In this case, it is necessary to reevaluate, for information included in the isolated node, a degree of relevance with another piece of information, and to reconstruct a structural model in which the isolated information is again connected to the structural model on the basis of a result of reevaluation. However, a huge amount of information-to-be-managed requires a huge amount of computation for reconstructing a structural model, which is a problem of causing a trouble in operation of information management.

In dealing with such problems, the information management device 10 according to the present example embodiment includes the identification unit 11 and the modification unit 12, and operates, for example, as exemplified in FIGS. 7A and 7B. In other words, the identification unit 11 identifies, when any piece of information among the information group 100 managed by constructing a structural model representing a mutual relevance is deleted from the structural model, information-to-be-modified having the relevance with information deleted (deleted information) meeting the modification target identification condition 140 in the structural model before deletion of the deleted information, among the plurality of pieces of managed information. The modification unit 12 modifies, on the basis of the relevance criterion 150 and a configuration of the structural model before deletion of the deleted information, the configuration of the structural model relating to the identified information-to-be-modified.

In other words, the information management device 10 according to the present example embodiment performs processing of identifying information having a high relevance (of a predetermined level or more) with deleted information as information-to-be-modified, and reconstructing a structural model regarding the identified information-to-be-modified on the basis of the relevance criterion 150. Then, as for information having a low relevance (of less than a predetermined level) with the deleted information, the information management device 10 does not perform processing of reconstructing the structural model but keeps the configuration of the structural model before deletion of the deleted information. For example, in the present example embodiment described above, as for the nodes 111 and 113 having a low relevance with deleted information 1100, the information management device 10 does not perform reconstruction but keeps the configuration of the structural model before deletion of information 1100, as exemplified in FIGS. 2, and 4 to 6. Accordingly, the information management device 10 according to the present example embodiment is able to efficiently perform processing of reconstructing a structural model representing a mutual relevance when any piece among a plurality of pieces of information managed by constructing the structural model is deleted.

Further, the information management device 10 according to the present example embodiment reconstructs the structural model in such a way that a connection relevance between parent information and a child node is kept, in the case of information among pieces of information identified as information-to-be-modified for which the connection relevance can be kept in a process of reconstructing the structural model. For example, in the present example embodiment described above, the information management device 10 does not perform reconstruction but keeps a parent-child relevance between information 1110 and the node 131 and a parent-child relevance between information 1120 and the node 132, as exemplified in FIGS. 2, and 4 to 6. Accordingly, the information management device 10 according to the present example embodiment is able to efficiently perform processing of reconstructing a structural model.

Further, the information management device 10 according to the present example embodiment is capable of reflecting, on the relevance criterion 150, a condition input by a user and relating to a characteristic that should be met by the structural model after the deleted information is deleted. Accordingly, the information management device 10 according to the present example embodiment is able to flexibly perform reconstruction of the structural model based on user's intention.

Note that the form of the structural model forming the information group 100 according to the present example embodiment is not limited to a tree structure. The form of the structural model according to the present example embodiment may be, for example, a weighted graph (a directed graph or an undirected graph). Further, the weighted graph may be a complete graph, or does not need to be a complete graph.

### Second Example Embodiment

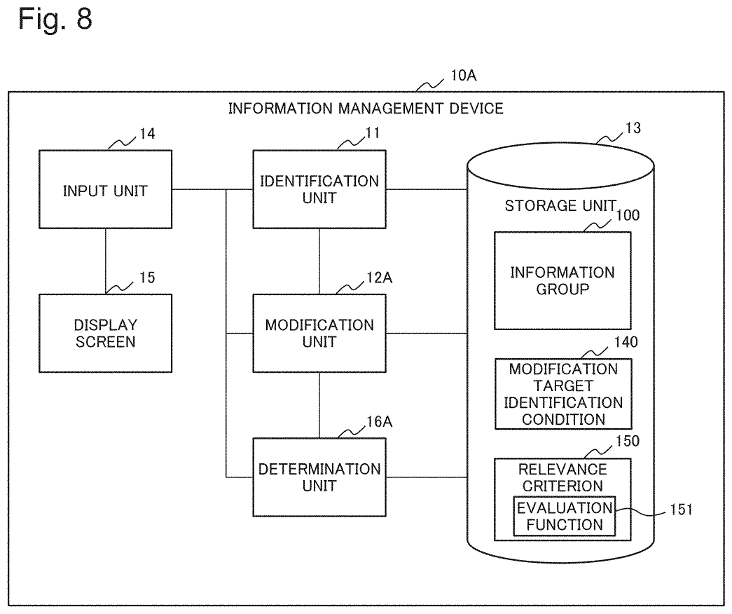

FIG. 8 is a block diagram conceptually illustrating a configuration of an information management device 10A according to a second example embodiment of the invention of the present application. The information management device 10A includes an identification unit 11, a modification unit 12A, a storage unit 13, an input unit 14, a display screen 15, and a determination unit 16A. In the present example embodiment, a configuration having a function similar to the above-described first example embodiment is assigned a reference numeral identical to the first example embodiment, and thereby detailed description thereof will be omitted.

The information management device 10A according to the present example embodiment has a configuration that includes: the determination unit 16A added to the information management device 10 according to the first example embodiment; and the modification unit 12A having a function partially added to the modification unit 12 according to the first example embodiment.

The determination unit 16A determines, when the modification unit 12A configures a plurality of pieces of information-to-be-modified collectively in a structural model after deletion of deleted information while keeping a configuration in the structural model before deletion of the deleted information, whether or not the information-to-be-modified meets a relevance criterion 150 regarding a relevance with another piece of information in the structural model.

When the determination unit 16A determines that the relevance does not meet the relevance criterion 150, the modification unit 12A modifies the configuration of the structural model relating to the information-to-be-modified in such a way that the relevance criterion 150 with another piece of information is met.

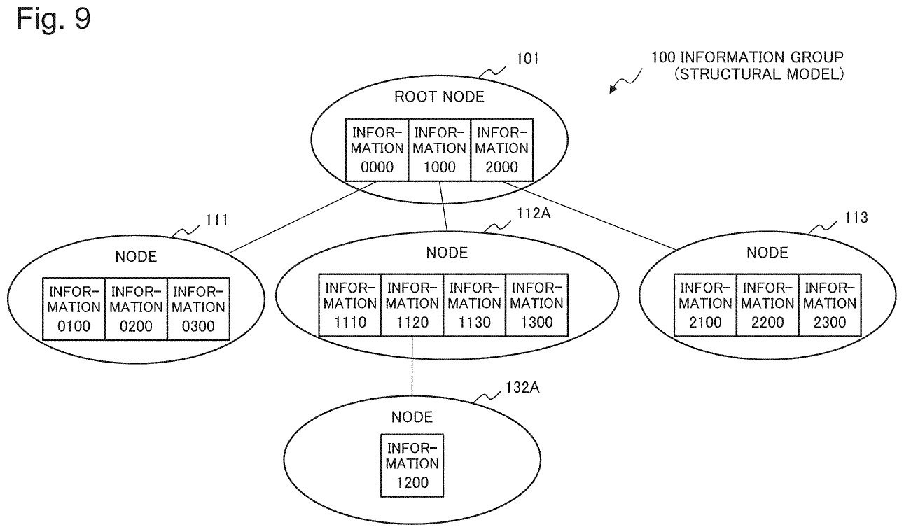

Next, processing of reconstructing the structural model performed by the identification unit 11, the modification unit 12A, and the determination unit 16A according to the present example embodiment when information 1100 is deleted from the structural model forming an information group 100 exemplified in FIG. 2 will be described in detail with reference to FIGS. 9 to 12. However, it is assumed that the configuration of the structural model before deletion of the deleted information exemplified in FIG. 2 is used also in description of the present example embodiment. Further, it is assumed that information is input by a user also in the present example embodiment, as exemplified in FIG. 3.

The identification unit 11 identifies information 1200, information 1300, information 1110, information 1120, and information 1130 as information-to-be-modified on the basis of a modification target identification condition 140, similarly to the case in the first example embodiment.

FIG. 9 is a diagram exemplifying a first intermediate form of the structural model in a process in which the identification unit 11, the modification unit 12A, and the determination unit 16A reconstruct the structural model forming the information group 100 after information 1100 is deleted from the information group 100 according to the present example embodiment. For the above-described five pieces of information-to-be-modified, the modification unit 12A modifies the structural model, for example, as exemplified in FIG. 9, similarly to the case in the first example embodiment.

As exemplified in FIG. 9, the modification unit 12A generates a node 112A as a child node of information 1000 having been parent information of deleted information 1100, similarly to the case of the first example embodiment. The modification unit 12A then generates a node 132A as a child node of information 1120, and allows the node 132A to include information 1200. Including information 1200 in the node 132A being a child node of information 1120 is due to a high evaluation value given by an evaluation function 151 relating to between information 1120 and information 1200.

Among the above-described five pieces of information-to-be-modified, the identification unit 11 identifies, as next information-to-be-modified, four pieces of information (that is, information 1110, information 1130, information 1300, and information 1200) having no child node in the structural model in a state exemplified in FIG. 9. For information having had a child node connected thereto in the structural model before deletion of information 1100 among the identified four pieces of information-to-be-modified, the modification unit 12A connects the child node having been connected to the information, directly to the information-to-be-modified. In the present example embodiment, the modification unit 12A connects a node 131 to information 1110 as a child node, and connects a node 133 to information 1130 as a child node in the structural model in a state exemplified in FIG. 9.

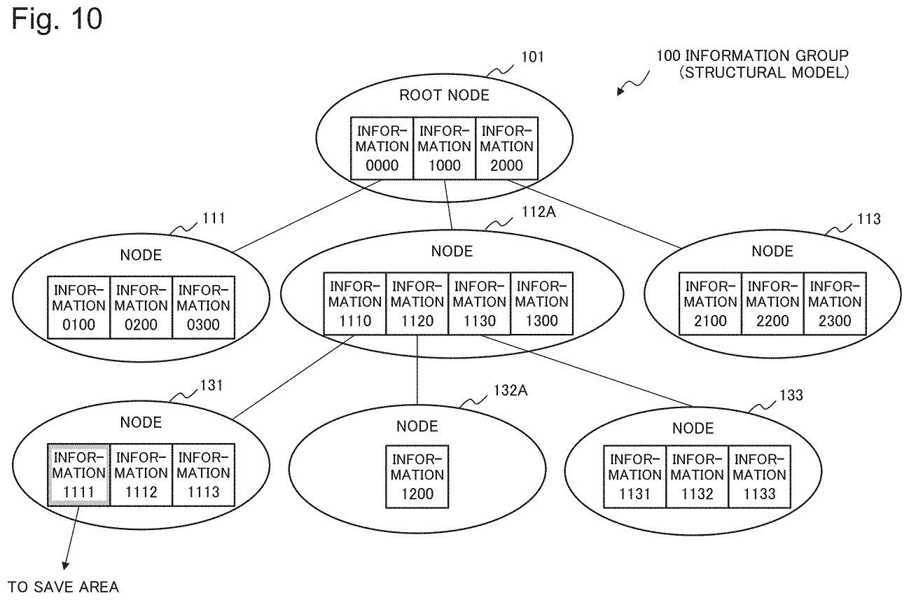

FIG. 10 is a diagram exemplifying a second intermediate form of the structural model representing a result of the above-described processing performed by the identification unit 11 and the modification unit 12A on the structural model in a state exemplified in FIG. 9.

The determination unit 16A determines whether or not information (that is, information 1111 to 1113 and information 1131 to 1133) included in the node 131 and the node 133 that are incorporated into the structural model after deletion of information 1100 while a configuration in the structural model before deletion of information 1100 is kept meets the relevance criterion 150, regarding a relevance with another piece of information in the structural model.

For example, it is assumed that information 1111 does not meet the relevance criterion 150 as a result of evaluation, performed by the determination unit 16A using the evaluation function 151, on a relevance between information 1000 and information 1111 to 1113 and 1131 to 1133. In this case, the determination unit 16A notifies the modification unit 12A that information 1111 does not meet the relevance criterion 150. In accordance with the notification from the determination unit 16A, the modification unit 12A temporarily moves information 1111 from the structural model to a save area (stack), as exemplified in FIG. 10.

The identification unit 11 identifies, as further next information-to-be-modified, information (that is, information 1120) having a child node, among the initially identified five pieces of information-to-be-modified. As exemplified in FIG. 2, information 1120 has the node 132 connected thereto as a child node in the structural model before deletion of information 1100. In this case, the modification unit 12A modifies the structural model in such a way that the node 132 exemplified in FIG. 2 and the node 132A exemplified in FIG. 10 are subordinate to information 1120.

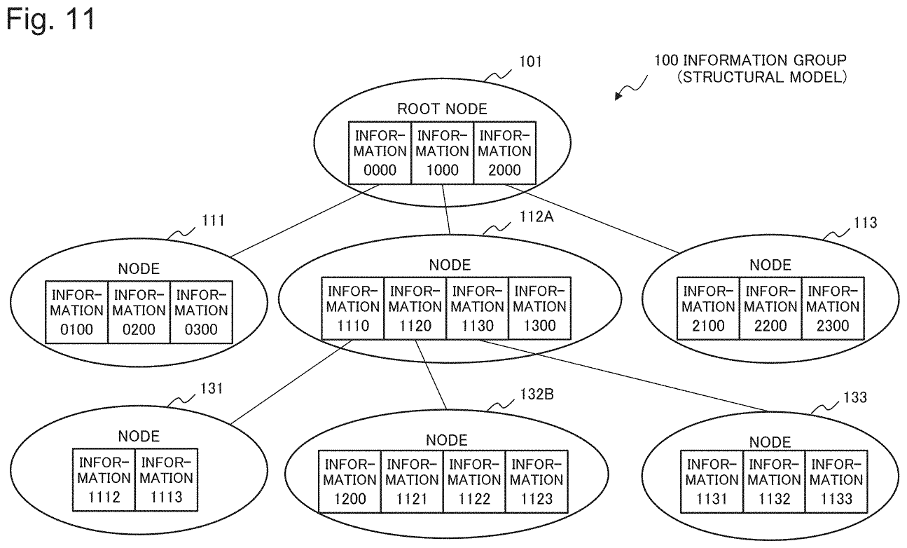

FIG. 11 is a diagram exemplifying a third intermediate form of the structural model representing a result of the above-described processing performed by the identification unit 11, the modification unit 12A, and the determination unit 16A on the structural model in a state exemplified in FIG. 10. The modification unit 12A generates a node 132B integrating the node 132 exemplified in FIG. 2 with the node 132A exemplified in FIG. 10, and allows the node 132B to include information 1200 and information 1121 to 1123. The number of pieces of information included in the node 132B meets “4” being the maximum information number per node input by a user, as exemplified in FIG. 3. Including information 1200 and information 1121 to 1123 in the same node is due to a low evaluation value given by the evaluation function 151 relating to between these four pieces of information.

Next, the modification unit 12A performs processing of incorporating information 1111 temporarily moved to the save area into the structural model in a state exemplified in FIG. 11, in such a way that a relevance with another piece of information meets the relevance criterion 150.

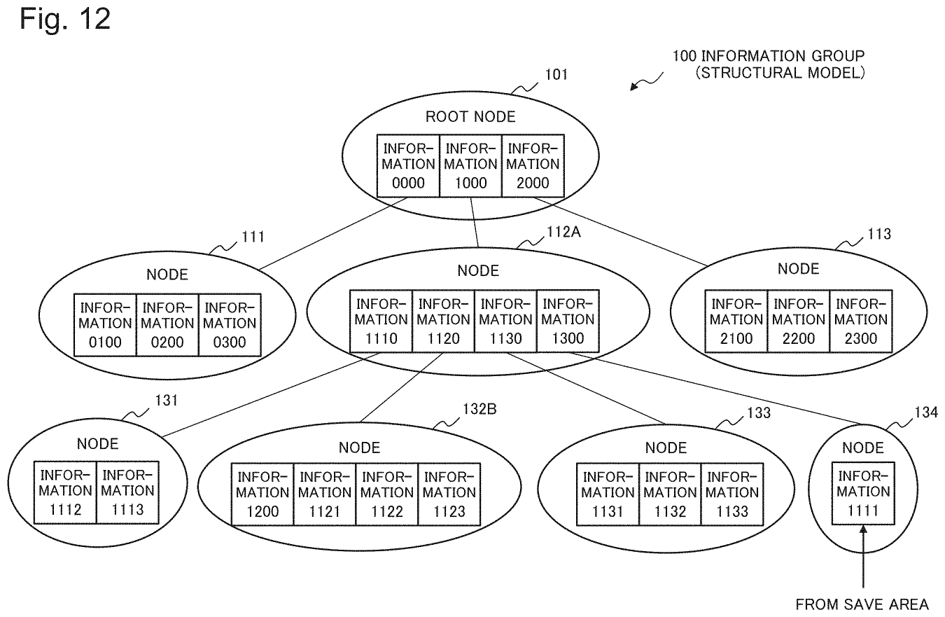

FIG. 12 is a diagram exemplifying a result of this processing performed by the modification unit 12A on the structural model in a state exemplified in FIG. 11. The modification unit 12A generates a node 134 as a child node of information 1300, and allows the node 134 to include information 1111. Including information 1111 in the node 134 being a child node of information 1300 is due to a high evaluation value given by the evaluation function 151 relating to between information 1111 and information 1300.

The structural model in a state exemplified in FIG. 12 includes all pieces of information other than information 1100 that are included in the structural model before deletion of information 1100 exemplified in FIG. 2. Thus, FIG. 12 represents a result (that is, a final form) of the structural model forming the information group 100 reconstructed by the information management device 10A after information 1100 is deleted from the information group 100 according to the present example embodiment.

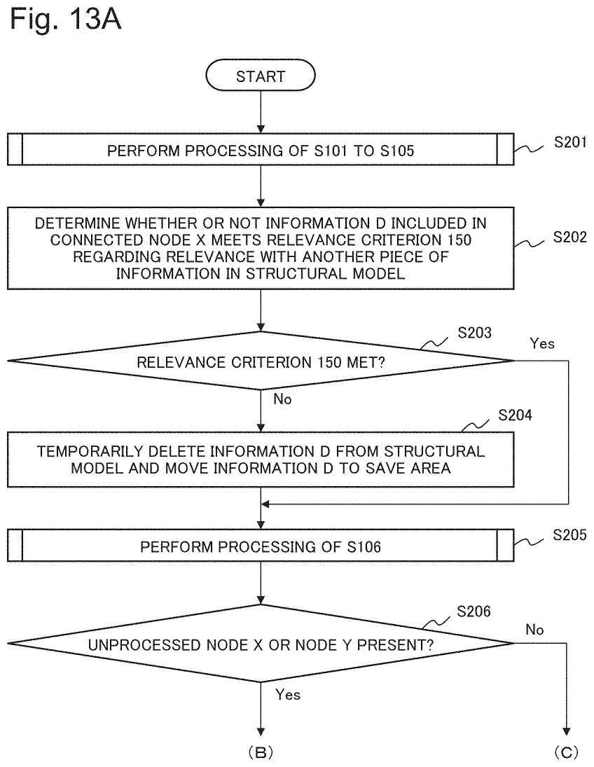

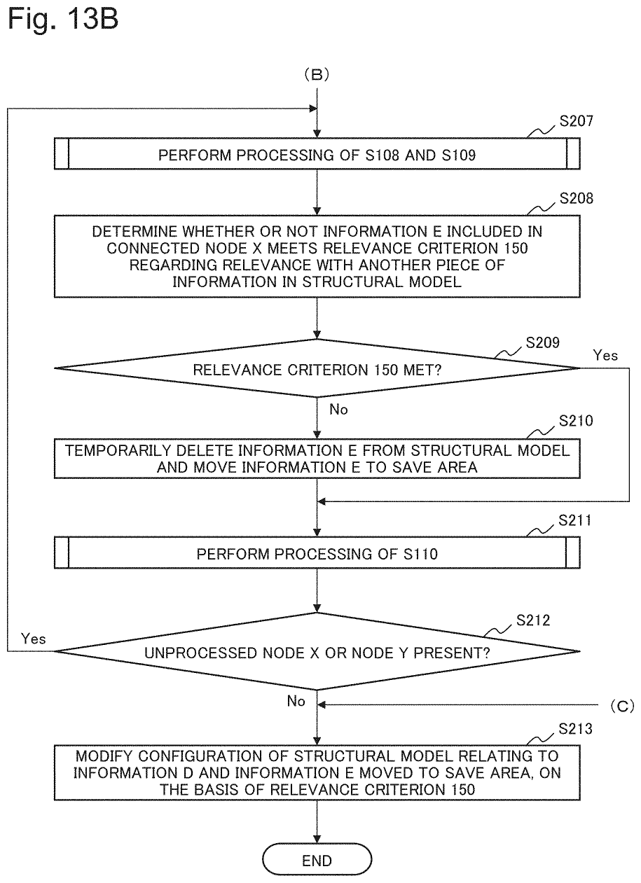

Next, an operation (processing) of the information management device 10A according to the present example embodiment will be described in detail with reference to flowcharts in FIGS. 13A and 13B.

The information management device 10A performs the processing of Steps S101 to S105 illustrated in FIG. 7A (Step S201). The determination unit 16A determines whether or not information D included in connected node X meets the relevance criterion 150 regarding a relevance with another piece of information in the structural model (Step S202).

When information D meets the relevance criterion 150 (Yes in Step S203), the processing proceeds to Step S205. When information D does not meet the relevance criterion (No in Step S203), the modification unit 12A temporarily deletes information D from the structural model and moves information D to the save area (Step S204). The information management device 10A performs the processing of Step S106 illustrated in FIG. 7A (Step S205).

When no unprocessed node X and node Y are present (No in Step S206), the processing proceeds to Step S213. When unprocessed node X or node Y is present (Yes in Step S206), the information management device 10A performs the processing of Steps S108 and S109 illustrated in FIG. 7B (Step S207).

The determination unit 16A determines whether or not information E included in connected node X meets the relevance criterion 150 regarding a relevance with another piece of information in the structural model (Step S208). When information E meets the relevance criterion 150 (Yes in Step S209), the processing proceeds to Step S211. When information E does not meet the relevance criterion 150 (No in Step S209), the modification unit 12A temporarily deletes information E from the structural model and moves information E to the save area (Step S210). The information management device 10A performs the processing of Step S110 illustrated in FIG. 7B (Step S205).

When unprocessed node X and node Y are present (Yes in Step S212), the processing returns to Step S207. When no unprocessed node X and node Y are present (No in Step S212), the modification unit 12A modifies, on the basis of the relevance criterion 150, the configuration of the structural model relating to information D and information E moved to the save area (Step S213), and the entire processing ends.

The information management device 10A according to the present example embodiment is able to efficiently perform processing of reconstructing a structural model representing a mutual relevance when any piece among a plurality of pieces of information managed by constructing the structural model is deleted. The reason is as described in relation to the first example embodiment.

Further, the information management device 10A according to the present example embodiment includes the determination unit 16A additionally to the configuration included in the information management device 10 according to the first example embodiment. When a structural model is reconstructed in such a way that a connection relevance between parent information and a child node is kept in order to efficiently perform reconstruction of the structural model, for example, a case may occur in which the relevance criterion 150 is not met between information included in the child node and any piece of information included in the information group 100. The determination unit 16A according to the present example embodiment detects the occurrence of the case. The modification unit 12A according to the present example embodiment then modifies the configuration of the structural model in such a way that the relevance criterion 150 is met regarding information included in the child node pertaining to the case. Accordingly, the information management device 10A according to the present example embodiment is able to perform processing of reconstructing a structural model accurately and efficiently.

Note that, in the present example embodiment described above, information 1111 temporarily saved in the save area (stack) has no child node connected thereto, but a case is also conceivable in which information having a child node connected thereto is saved in the save area. In this case, the information management device 10A may perform processing similar to when the information to be saved in the save area is a target to be deleted. For example, a case in which a relevance between information 1000 and information 1110 illustrated in FIG. 10 does not meet the relevance criterion 150 (that is, a case in which information 1110 needs to be moved to the save area) in the present example embodiment described above will be considered. In this case, the information management device 10A may perform processing of modifying the configuration of the structural model regarding information 1111 to 1113, information 1120, information 1130, and information 1300, before modifying the configuration of the structural model regarding information 1121 to 1123 and information 1200.

Further, the information management device 10A according to the present example embodiment may be adapted to perform processing of the determination unit 16A and the modification unit 12A when a predetermined condition is met. For example, when it is considered that, from a characteristic of the information group 100, a case in which the relevance criterion 150 is not met regarding between any pieces of information included in the information group 100 extremely rarely occurs, the information management device 10A may be adapted not to perform processing of the determination unit 16A and the modification unit 12A.

Further, the information management device 10A according to the present example embodiment may perform processing of the determination unit 16A and the modification unit 12A after a series of processing of reconstructing the structural model by deleting the deleted information is completed. In this case, the information management device 10A may perform processing of the determination unit 16A and the modification unit 12A on all pieces of information having a child node in the reconstructed structural model, or only on information having a particular child node.

### Third Example Embodiment

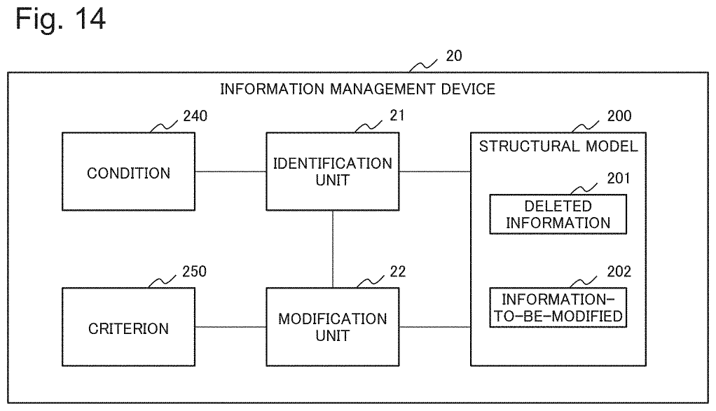

FIG. 14 is a block diagram conceptually illustrating a configuration of an information management device 20 according to a third example embodiment of the invention of the present application.

The information management device 20 according to the present example embodiment includes an identification unit 21 and a modification unit 22.

The identification unit 21 identifies information-to-be-modified 202 when any piece of information (deleted information 201) among a plurality of pieces of information managed by constructing a structural model 200 representing a mutual relevance is deleted from the structural model 200. The information-to-be-modified 202 is information having a relevance with the deleted information 201 meeting a predetermined condition 240 in the structural model 200 before deletion of the deleted information 201, among the plurality of pieces of managed information.

The modification unit 22 modifies a configuration of the structural model relating to the identified information-to-be-modified 202 on the basis of a criterion 250 relating to a relevance and the configuration of the structural model 200 before deletion of the deleted information 201.

The information management device 20 according to the present example embodiment is able to efficiently perform processing of reconstructing the structural model 200 representing a mutual relevance when any piece among a plurality of pieces of information managed by constructing the structural model 200 is deleted. The reason is that the information management device 20 identifies, as the information-to-be-modified 202, information having a relevance with the deleted information 201 meeting the condition 240, and modifies the configuration of the structural model 200 relating to the information-to-be-modified 202 on the basis of the criterion 250 and the configuration of the structural model 200 before deletion of the deleted information 201.

### Hardware Configuration Example

In each example embodiment described above, each unit in the information management devices 10, 10A, and 20 illustrated in FIGS. 1, 8, and 14 can be implemented by dedicated hardware (HW) (electronic circuit). Further, in FIGS. 1, 8, and 14, at least the following configuration can be regarded as a functional (processing) unit (software module) of a software program.
the identification units 11 and 21,
the modification units 12, 12A, and 22,
a memory control function in the storage unit 13,
the input unit 14,
the determination unit 16A.

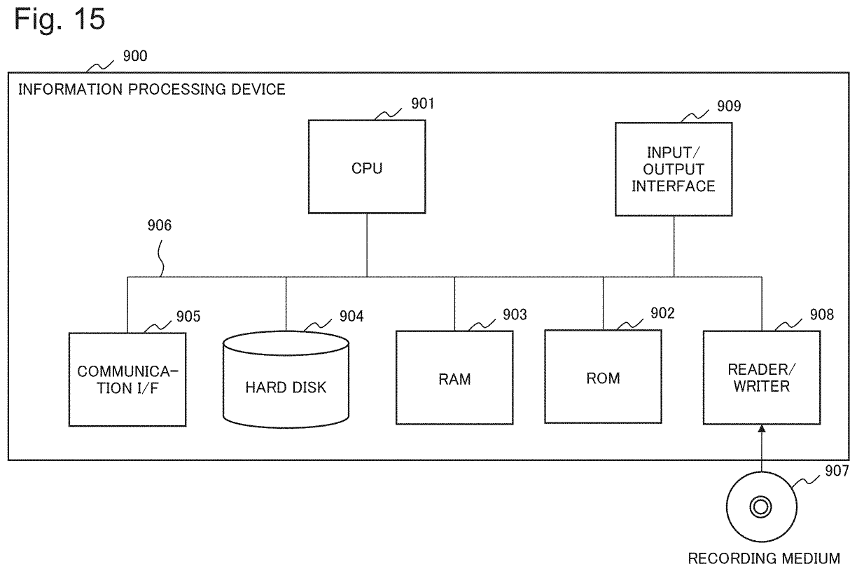

However, division of these units illustrated in the drawings is a configuration for convenience of illustration, and various configurations can be assumed for implementation. One example of a hardware environment in this case will be described with reference to FIG. 15.

FIG. 15 is a diagram illustratively describing a configuration of an information processing device 900 (a computer) capable of executing the information management device according to each example embodiment of the invention of the present application. In other words, FIG. 15 represents a hardware environment being a configuration of a computer (an information processing device) capable of implementing the information management device or a part thereof illustrated in FIGS. 1, 8, and 14, and being capable of implementing the respective functions according to the above-described example embodiments. The information processing device 900 illustrated in FIG. 15 includes the following components.
a central processing unit (CPU) 901,
a read only memory (ROM) 902,
a random access memory (RAM) 903,
a hard disk (a storage device) 904,
a communication interface 905 with an external device such as a radio transmission/reception unit,
a bus 906 (a communication line),
a data readable/writable reader/writer 908 stored on a recording medium 907 such as a compact disc read-only memory (CD-ROM),
an input/output interface 909.

In other words, the information processing device 900 including the above-described components is a general computer in which these configurations are connected via the bus 906. The information processing device 900 may include a plurality of the CPUs 901, or may include the CPU 901 composed of multiple cores.

Then, the invention of the present application described by using the above-described example embodiment as an example supplies the information processing device 900 illustrated in FIG. 15 with a computer program capable of implementing the following function. The function is the above-described configuration in the block configuration diagram (FIGS. 1, 8, and 14) referred to in the description of the example embodiment, or the function in the flowchart (FIGS. 7A and 7B, and FIGS. 13A and 13B). The invention of the present application is thereafter achieved by reading the computer program into the CPU 901 of the hardware, and interpreting and executing the computer program. Further, the computer program supplied in the device may be stored in a readable/writable volatile memory (the RAM 903), or in a non-volatile storage device such as the ROM 902 and the hard disk 904.

Further, in the case described above, as a method of supplying a computer program in the hardware, a general procedure can be adopted nowadays. Examples of the procedure include, for example, a method of installing a computer program in the device via the recording medium 907 of various types such as a CD-ROM, and a method of downloading a computer program externally via a communication line such as the Internet. Then, in such a case, the invention of the present application can be regarded as being configured by a code composing the computer program, or by the recording medium 907 on which the code is stored.

The invention of the present application has been described by using each of the example embodiments described above as an exemplary example. However, the invention of the present application is not limited to the above-described example embodiments. In other words, various modes that a person skilled in the art can understand can be applied to the invention of the present application within the scope of the invention of the present application.

This application is based upon and claims the benefit of priority from Japanese patent application No. 2017-044847, filed on Mar. 9, 2017, the disclosure of which is incorporated herein in its entirety by reference.

### REFERENCE SIGNS LIST

10 Information management device

10A Information management device

100 Information group

11 Identification unit

12 Modification unit

12A Modification unit

13 Storage unit

140 Modification target identification condition

150 Relevance criterion

151 Evaluation function

14 Input unit

15 Display screen

16A Determination unit

20 Information management device

21 Identification unit

22 Modification unit

200 Structural model

201 Deleted information

202 Information-to-be-modified

240 Condition

250 Criterion

900 Information processing device

901 CPU

902 ROM

903 RAM

904 Hard disk (storage device)

905 Communication interface

906 Bus

907 Recording medium

908 Reader/writer

909 Input/output interface

What is claimed is:

1. An information management device comprising:
identification unit configured to identify, when any piece of information among a plurality of pieces of managed information managed by constructing a structural model representing a mutual relevance is deleted from the structural model, information-to-be-modified having the relevance with the information being deleted (“deleted information” hereinafter) meeting a predetermined condition in the structural model before deletion of the deleted information, among the plurality of pieces of the managed information; and
modification unit configured to modify, based on a criterion relating to the relevance and a configuration of the structural model before deletion of the deleted information, a configuration of the structural model relating to the information-to-be-modified being identified.

2. The information management device according to claim 1, wherein
the identification unit identifies, in the structural model in which one or more nodes including the managed information are connected by a tree structure, the managed information included in first one of the nodes in which the deleted information has been included and in second one of the nodes having been connected in a terminal direction of the structural model with the first node as an origin before the deleted information is deleted, as the information-to-be-modified.

3. The information management device according to claim 2, wherein
the structural model having the tree structure is configured in such a way that the higher the mutual relevance between pieces of the managed information is, the more likely the pieces of the managed information are included in an identical one of the nodes being in the terminal direction of the structural model.

4. The information management device according to claim 1, further comprising
determination unit configured to determine, when the modification unit configures a plurality of pieces of the information-to-be-modified collectively in the structural model after the deletion of the deleted information while keeping a configuration in the structural model before the deletion of the deleted information, whether or not the information-to-be-modified meets the criterion relating to the relevance with another piece of the managed information in the structural model, wherein
the modification unit modifies, when the determination unit determines that the criterion relating to the relevance is not met, the configuration of the structural model relating to the information-to-be-modified in such a way that the criterion relating to the relevance with the another piece of the managed information is met.

5. The information management device according to claim 1, wherein
the criterion relating to the relevance includes an externally input condition relating to a characteristic that needs to be met by the structural model after the deleted information is deleted.

6. The information management device according to claim 1, wherein
the criterion relating to the relevance includes an evaluation function that outputs, based on two pieces of the managed information, a value indicating the relevance between the two pieces of the managed information.

7. The information management device according to claim 1, wherein
the relevance is a similarity between pieces of the managed information.

8. The information management device according to claim 1, wherein
the managed information represents a text, an image, or a molecular structure of a substance.

9. An information management method comprising:
by using an information processing device,
identifying, when any piece of information among a plurality of pieces of managed information managed by constructing a structural model representing a mutual relevance is deleted from the structural model, information-to-be-modified having the relevance with the information being deleted (“deleted information” hereinafter) meeting a predetermined condition in the structural model before deletion of the deleted information, among the plurality of pieces of the managed information; and
modifying, based on a criterion relating to the relevance and a configuration of the structural model before deletion of the deleted information, a configuration of the structural model relating to the information-to-be-modified being identified.

10. A non-transitory computer-readable recording medium that stores an information management program for causing a computer to execute:
identification processing of identifying, when any piece of information among a plurality of pieces of managed information managed by constructing a structural model representing a mutual relevance is deleted from the structural model, information-to-be-modified having the relevance with the information being deleted (“deleted information” hereinafter) meeting a predetermined condition in the structural model before deletion of the deleted information, among the plurality of pieces of the managed information; and
modification processing of modifying, based on a criterion relating to the relevance and a configuration of the structural model before deletion of the deleted information, a configuration of the structural model relating to the information-to-be-modified being identified.
